(19) United States
(12) Patent Application Publication
(10) Pub. No.: US 2026/0217130 A1
(43) Pub. Date: Jul. 30, 2026

(54) VEHICLE CONTROL DEVICE, VEHICLE CONTROL METHOD, AND VEHICLE CONTROL SYSTEM

(71) Applicant: Astemo, Ltd., Tokyo (JP)

(72) Inventors: Satoshi KANEKO, Hitachinaka-shi, Ibaraki (JP); Keisuke SUZUKI, Hitachinaka-shi, Ibaraki (JP)

(21) Appl. No.: 19/148,894

(22) PCT Filed: Jan. 11, 2024
(86) PCT No.: PCT/JP2024/000348

§ 371 Date: Jul. 17, 2025

(30) Foreign Application Priority Data
Jan. 23, 2023 (JP) 2023-008009

(51) Int. Cl. B60L 7/16; B60L 7/12; B60L 15/20

(52) U.S. Cl. CPC B60L 7/16; B60L 7/12; B60L 15/2009; B60L 2210/14; B60L 2240/12; B60L 2240/18; B60L 2240/24

(57) ABSTRACT

In a case in which a vehicle is to be decelerated through a regenerative braking force of rear wheels, when the vehicle is turned, a vehicle control device reduces the regenerative braking force of the rear wheels from a regenerative braking force at a time when the vehicle is not turned, and increases a friction braking force of four wheels by an amount corresponding to the regenerative braking force of the rear wheel to be reduced.

### TECHNICAL FIELD

The present invention relates to a vehicle control device, a vehicle control method, and a vehicle control system.

### BACKGROUND ART

In Patent Literature 1, there is disclosed a technology of, when a difference between a front wheel speed and a rear wheel speed exceeds a threshold value at the time of braking only through a regenerative braking force during turn, reducing the regenerative braking force and increasing a friction braking force of four wheels.

### CITATION LIST

### Patent Literature

PTL 1: JP 2012-060753 A

### SUMMARY OF INVENTION

### Technical Problem

However, in the above-mentioned related art, the reduction in regenerative braking force and the increase in friction braking force are started based on a behavior of a vehicle, and hence there is a fear in that it may not be possible to increase stability of the vehicle from an initial stage of the turn deceleration.

One object of the present invention is to provide a vehicle control device, a vehicle control method, and a vehicle control system with which stability of a vehicle can be increased from an initial stage of turn acceleration and deceleration of the vehicle.

### Solution to Problem

In a vehicle control device according to one embodiment of the present invention, a control part outputs a control command to, in a case in which a vehicle is to be decelerated through a regenerative braking force of a regenerative wheel being any one of a front wheel or a rear wheel of the vehicle, when the vehicle is turned, reduce the regenerative braking force of the regenerative wheel from a regenerative braking force at a time when the vehicle is not turned, and increase a friction braking force by an amount corresponding to the regenerative braking force of the regenerative wheel to be reduced.

According to the one embodiment of the present invention, it is possible to increase the stability of the vehicle from the initial stage of turn acceleration and deceleration of the vehicle.

### BRIEF DESCRIPTION OF DRAWINGS

FIG. 1 is a schematic diagram of an electric vehicle (1) including a vehicle control system according to a first embodiment of the present invention.

FIG. 2 is a flowchart for illustrating a flow of braking force switching control processing at a turn start time during deceleration in a vehicle control device (17) according to the first embodiment.

FIG. 3 is a flowchart for illustrating a flow of the braking force switching control processing at a deceleration start time during turn in the vehicle control device (17) according to the first embodiment.

FIG. 4 is a setting map for a first steering angle change amount threshold value in accordance with a vehicle speed in the first embodiment.

FIG. 5 is a setting map for a switching rate in accordance with an estimated road surface u in the first embodiment.

FIG. 6 is a setting map for a first brake operation change amount threshold value in accordance with a lateral G in the first embodiment.

FIG. 7 is a time chart of a brake operation amount, a braking force, a wheel speed, and a yaw rate exhibited when a driver executes a brake operation during a steady turn in a related-art rear-wheel-drive electric vehicle.

FIG. 8 is a time chart of a steering operation, the braking force, the wheel speed, the yaw rate, and the estimated road surface u for illustrating an operation of braking force switching control at the turn start time during the deceleration on a low u road in the vehicle control device (17) according to the first embodiment.

FIG. 9 is a time chart of the steering operation, the braking force, the wheel speed, the yaw rate, and the estimated road surface u for illustrating the operation of the braking force switching control at the turn start time during the deceleration on a high u road in the vehicle control device (17) according to the first embodiment.

FIG. 10 is a time chart of a brake operation, the braking force, the wheel speed, the yaw rate, and the estimated road surface u for illustrating the operation of the braking force switching control at the deceleration start time during the turn on the low p road in the vehicle control device (17) according to the first embodiment.

FIG. 11 is a time chart of the brake operation, the braking force, the wheel speed, the yaw rate, and the estimated road surface u for illustrating the operation of the braking force switching control at the deceleration start time during the turn on the high p road in the vehicle control device (17) according to the first embodiment.

FIG. 12 is a schematic diagram of a powertrain of an electric vehicle (1A) including a vehicle control system according to a second embodiment of the present invention.

FIG. 13 is a time chart of the brake operation amount, the braking force, the wheel speed, and the yaw rate exhibited when the driver executes the brake operation during the steady turn in a related-art front-wheel-drive electric vehicle.

FIG. 14 is a time chart of the brake operation, the braking force, the wheel speed, the yaw rate, and the estimated road surface u for illustrating the operation of the braking force switching control at the deceleration start time during the turn on the low u road in the vehicle control device (17) according to the second embodiment.

FIG. 15 is a time chart of the brake operation, the braking force, the wheel speed, the yaw rate, and the estimated road surface u for illustrating the operation of the braking force switching control at the deceleration start time during the turn on the high u road in the vehicle control device (17) according to the second embodiment.

FIG. 16 is a schematic diagram of a powertrain of an electric vehicle (1B) including a vehicle control system according to a third embodiment of the present invention.

FIG. 17 is a time chart of the brake operation, a torque command, the wheel speed, the yaw rate, and the estimated road surface u exhibited when the driver executes the brake operation during the steady turn in a related-art four-wheel-drive electric vehicle.

FIG. 18 is a time chart of the brake operation, the torque command, the wheel speed, the yaw rate, and the estimated road surface u for illustrating the operation of the braking force switching control at the deceleration start time during the turn on the low u road in the vehicle control device (17) according to the third embodiment.

FIG. 19 is a time chart of the brake operation, the torque command, the wheel speed, the yaw rate, and the estimated road surface u for illustrating the operation of the braking force switching control at the deceleration start time during the turn on the high p road in the vehicle control device (17) according to the third embodiment.

FIG. 20 is a flowchart for illustrating a flow of driving force switching control processing at the turn start time during the acceleration in the vehicle control device (17) in a fourth embodiment of the present invention.

FIG. 21 is a flowchart for illustrating a flow of the braking force switching control processing at an acceleration start time during the turn in the vehicle control device (17) according to the fourth embodiment.

FIG. 22 is a setting map for the switching rate in accordance with the estimated road surface u in the fourth embodiment.

FIG. 23 is a time chart of an accelerator operation, a driving force, the wheel speed, the yaw rate, and the estimated road surface u exhibited when the driver executes the accelerator operation during the steady turn in the related-art four-wheel-drive electric vehicle.

FIG. 24 is a time chart of the accelerator operation, the driving force, the wheel speed, the yaw rate, and the estimated road surface u for illustrating the operation of driving force switching control at the acceleration start time during the turn on the low u road in the vehicle control device (17) according to the fourth embodiment.

FIG. 25 is a time chart of the accelerator operation, the driving force, the wheel speed, the yaw rate, and the estimated road surface u for illustrating the operation of the braking force switching control at the deceleration start time during the turn on the high u road in the vehicle control device (17) according to the fourth embodiment.

### DESCRIPTION OF EMBODIMENTS

### First Embodiment

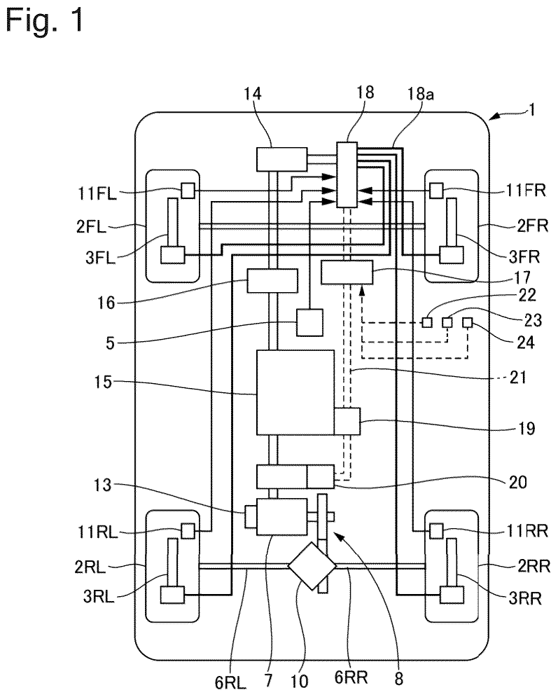

FIG. 1 is a schematic diagram of an electric vehicle 1 including a vehicle control system according to a first embodiment of the present invention.

The electric vehicle 1 includes front wheels 2FL and 2FR, rear wheels 2RL and 2RR, and friction brakes (friction braking device) 3FL, 3FR, 3RL, and 3RR (the friction brake for each wheel is hereinafter also generally referred to as “friction brake 3”) each of which is provided to one of wheels, and generates a friction braking force on the wheel.

The electric vehicle 1 includes a rear motor generator (a regenerative braking device and driving device, and hereinafter referred to as “rear motor”) 7 which outputs torques (driving torque and regenerative torque) to the rear wheels 2RL and 2RR. The rear wheels 2RL and 2RR are driving wheels and regenerative wheels. A power transmission between the rear motor 7 and the rear wheels 2RL and 2RR is executed through a speed reducer 8, a differential 10, and rear axles 6RL and 6RR.

The wheels 2FL, 2FR, 2RL, and 2RR include wheel speed sensors 11FL, 11FR, 11RL, and 11RR which detect wheel speeds, respectively. The rear motor 7 includes a rear wheel resolver 13 which detects a motor speed (motor rotation number). Moreover, the electric vehicle 1 includes a G sensor 5 which detects an acceleration in a front-rear direction of the vehicle (longitudinal G) and an acceleration in a lateral direction of the vehicle (lateral G).

The friction brake 3 presses brake pads against a brake rotor which rotates integrally with each wheel in a rotation axis direction of the wheel, to thereby generate a braking force through use of a friction force. As the friction brake 3 in the first embodiment, description is given of a configuration in which the brake pads are pressed by a wheel cylinder operated through use of a brake hydraulic pressure, but the friction brake 3 may have such a configuration that the brake pads are pressed through intermediation of a ball screw mechanism driven by an electric motor or the like, and is not particularly limited.

The electric vehicle 1 includes a low-voltage battery 14 and a high-voltage battery 15. The low-voltage battery 14 is, for example, a lead storage battery. The high-voltage battery 15 is, for example, a lithium-ion battery or a nickel-hydrogen battery. The high-voltage battery 15 is charged by electric power boosted by a DC-DC converter 16.

The electric vehicle 1 includes a vehicle control device (control part) 17, a brake control device 18, a rear motor control device 20, and a battery control device 19. The respective control devices 17, 18, and 20 mutually share information through a CAN bus 21.

The vehicle control device 17 acquires information from various types of sensors such as the rear wheel resolver 13, an accelerator pedal sensor 22 which detects an accelerator operation amount, a brake sensor 23 which detects a brake operation amount, and a steering angle sensor 24 which detects a steering angle of a steering wheel (not shown), to thereby execute integrated control for the vehicle. The vehicle control device 17 sets a target driving force in accordance with an accelerator operation and the like of a driver, and outputs a driving torque command for achieving the target driving force to the rear motor control device 20. Moreover, the vehicle control device 17 sets a target braking force in accordance with a brake operation of the driver and the like, and outputs a regenerative torque command for achieving the target braking force to the rear motor control device 20. When the target braking force cannot be achieved only through use of the regenerative braking force of the rear motor 7, the vehicle control device 17 outputs a friction braking torque command for achieving a complementary braking force to the brake control device 18, to thereby execute regenerative cooperative control of achieving the target braking force through use of the regenerative braking force and the friction braking force.

The brake control device 18 generates a brake hydraulic pressure required for each wheel based on the friction braking torque command, and outputs the brake hydraulic pressure to each friction brake 3 via a hydraulic pipe 18a.

The battery control device 19 monitors a charge/discharge state of the high-voltage battery 15 and unit cells forming the high-voltage battery 15. The battery control device 19 calculates a battery requested torque limit value based on the charge/discharge state of the high-voltage battery 15 and the like. The battery requested torque limit value is the maximum torque allowed in the rear motor 7. For example, when a charging amount of the high-voltage battery 15 is becoming smaller, the battery requested torque limit value is set to a smaller value than a normal value.

The rear motor control device 20 controls electric power to be supplied to the rear motor 7 based on the driving torque command or the regenerative torque command.

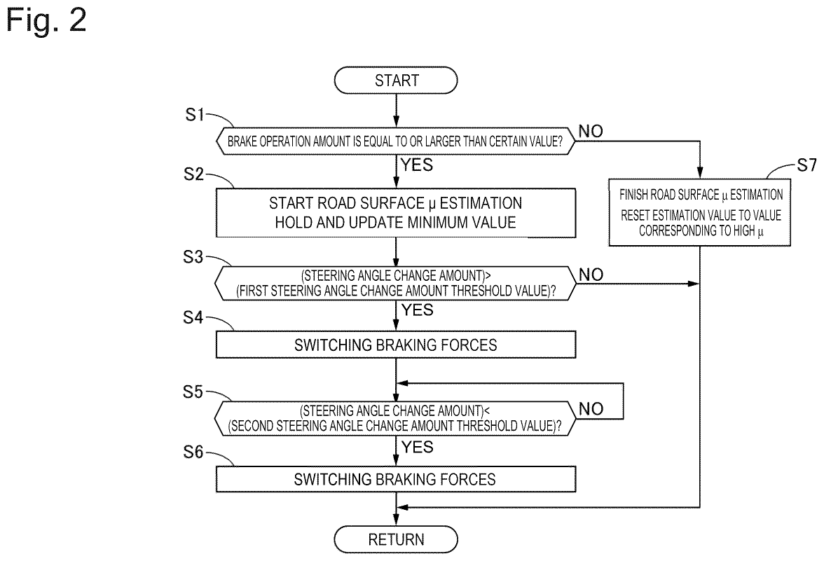

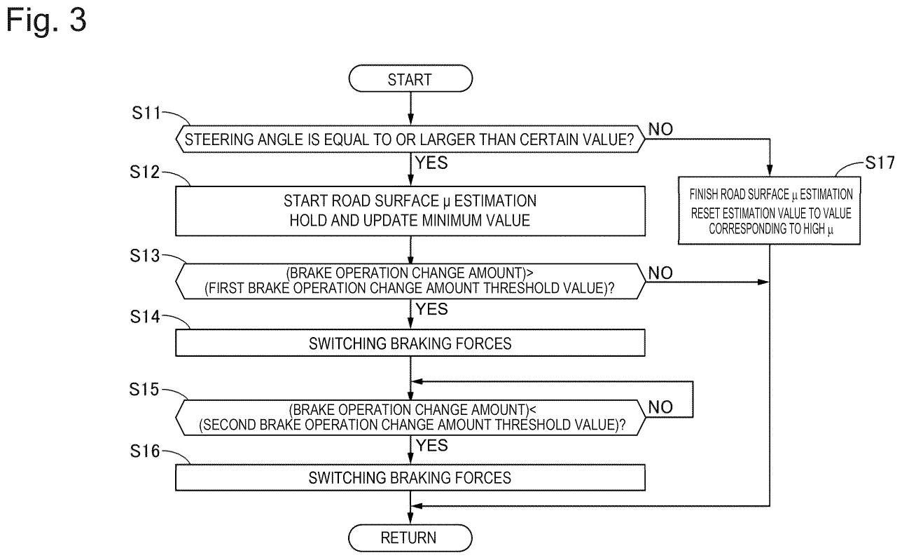

In the electric vehicle 1 in the first embodiment, the following switching of the braking forces is executed. The switching of the braking forces aims to increase stability of the vehicle at a turn and deceleration time, and, when the vehicle is decelerated through use of the regenerative braking force of the rear wheels 2RL and 2RR and the vehicle is turned, reduces the regenerative braking force of the rear wheels 2RL and 2RR, and increases the friction braking force of each of the wheels 2FL, 2FR, 2RL, and 2RR by an amount corresponding to the regenerative braking force to be reduced. Here, “turn” includes not only travel on a curve, but also a lane change and an obstacle avoidance operation, for example. FIG. 2 and FIG. 3 are flowcharts for illustrating a flow of braking force switching control processing by the vehicle control device 17 according to the first embodiment. The flowcharts illustrated in FIG. 2 and FIG. 3 are repeatedly executed in parallel at a predetermined control cycle while the vehicle is active. The flowchart of FIG. 2 is first described.

FIG. 2 is a flowchart for illustrating a flow of braking force switching control processing at the turn start time during the deceleration in the vehicle control device 17 according to the first embodiment.

In Step S1, the vehicle control device 17 determines whether or not the brake operation amount is equal to or larger than a certain value. When the determination of “YES” is made, the process proceeds to Step S2, and when the determination of “NO” is made, the process proceeds to Step S7.

In Step S2, estimation of a road surface friction coefficient (hereinafter also referred to as “road surface u”) is started, and the minimum value of the estimated road surface pis held and updated. A calculation method for the estimated road surface p has been known, and there have been known, for example, a method of calculating the estimated road surface u from a detected slip amount of the wheel, a method of calculating the estimated road surface u from a characteristic of a road surface reaction force in response to the steering angle, and the like.

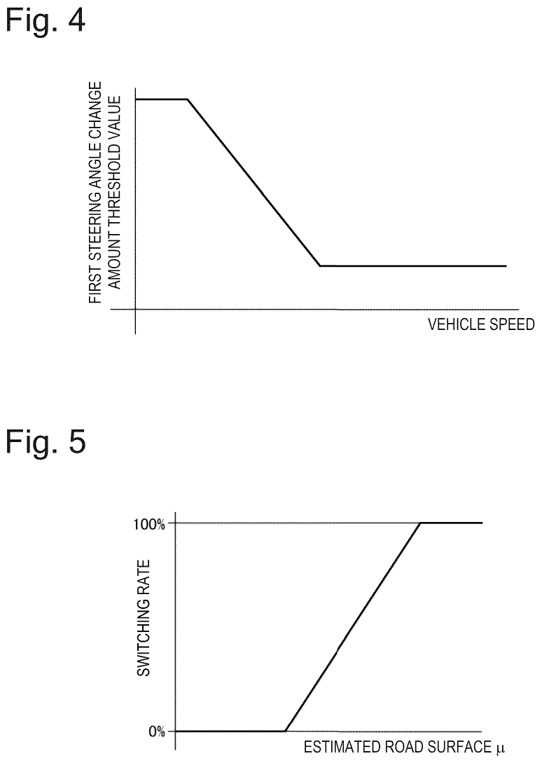

In Step S3, it is determined whether or not a steering angle change amount being a derivative of the steering angle exceeds a first steering angle change amount threshold value. When the determination of “YES” is made, the process proceeds to Step S4, and when the determination of “NO” is made, the process proceeds to “RETURN.” FIG. 4 is a setting map for the first steering angle change amount threshold value in accordance with the vehicle speed in the first embodiment. A lateral G generated in response to the steering angle changes in accordance with the vehicle speed. Thus, the map of FIG. 4 is set such that the first steering angle change amount decreases as the vehicle speed increases. The first steering angle change amount threshold value takes the maximum value in an extremely low speed range in which the lateral G is not generated, and takes the minimum value in a high speed range in which the lateral G exceeds a predetermined value.

In Step S4, the vehicle control device 17 executes switching of the braking forces of reducing the regenerative braking force of the rear wheels 2RL and 2RR to zero at a predetermined reduction gradient, and increasing the friction braking force of the four wheels 2FL, 2FR, 2RL, and 2RR by the amount corresponding to the regenerative braking force to be reduced.

In Step S5, it is determined whether or not the steering angle change amount falls below a second steering angle change amount threshold value. When the determination of “YES” is made, the process proceeds to Step S6, and when the determination of “NO” is made, the vehicle control device 17 repeats Step S5. The second steering angle change amount threshold value is a characteristic obtained by offsetting the characteristic of the first steering angle change amount threshold value shown in FIG. 4 to a plus side by a predetermined amount.

In Step S6, the vehicle control device 17 executes switching of the braking forces of reducing the increased friction braking force of the four wheels 2FL, 2FR, 2RL, and 2RR at a predetermined reduction gradient, and increasing the regenerative braking force of the rear wheels 2RL and 2RR by an amount corresponding to the friction braking force to be reduced, to thereby return a distribution of the total braking force of the vehicle to the regenerative braking force and the friction braking force to a distribution before the steering. At this time, the increase gradient of the regenerative braking force is set to be smaller in gradient (change rate) than the reduction gradient of the regenerative braking force in Step S4. Moreover, when a case in which the regenerative braking force is increased to the target braking force corresponds to a switching rate of 100%, the rate of the increase in regenerative braking force with respect to the target braking force, that is, the switching rate, is changed in accordance with (the minimum value of) the stored estimated road surface u. FIG. 5 is a setting map for the switching rate in accordance with the estimated road surface μ in the first embodiment. The map of FIG. 5 is set such that, when the estimated road surface μ is considered as a high μ, the switching rate is 100% and, when the road surface μ is equal to or less than that, the switching rate decreases as the estimated road surface μ is lower. When the estimated road surface μ is considered as a low μ, the switching rate is 0%, and the switching of the braking forces is not executed in this case.

In Step S7, the estimation of the road surface μ is finished, and the estimated road surface μ is reset to a value corresponding to the high μ.

The flowchart of FIG. 3 is described next. FIG. 3 is a flowchart for illustrating a flow of the braking force switching control processing at the deceleration start time during the turn in the vehicle control device 17 according to the first embodiment.

In Step S11, the vehicle control device 17 determines whether or not the steering angle is equal to or larger than a certain value. When the determination of “YES” is made, the process proceeds to Step S2, and when the determination of “NO” is made, the process proceeds to Step S17.

In Step S12, estimation of the road surface μ is started in the same manner as in Step S2, and the minimum value of the estimated road surface μ is held and updated.

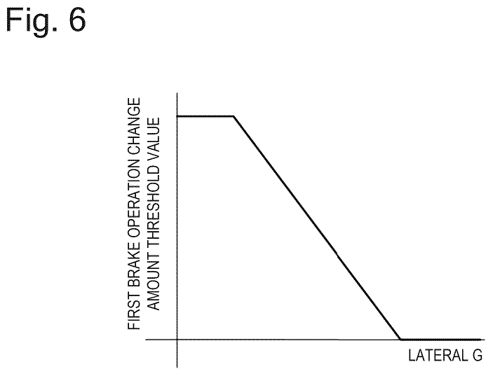

In Step S13, the vehicle control device 17 determines whether or not a brake operation change amount being a derivative of the brake operation amount exceeds a first brake operation change amount threshold value. When the determination of “YES” is made, the process proceeds to Step S14, and when the determination of “NO” is made, the process proceeds to “RETURN.” FIG. 6 is a setting map for the first brake operation change amount threshold value in accordance with the lateral G in the first embodiment. The map of FIG. 6 is set such that the first brake operation change amount threshold value decreases as the lateral G increases. The first brake operation change amount threshold value takes the maximum value in a low lateral G region in which a turning inner wheel does not slip and takes the minimum value in a high lateral G region in which the turning inner wheel slips.

In Step S14, in the same manner as in Step S4, the vehicle control device 17 executes switching of the braking forces of reducing the regenerative braking force of the rear wheels 2RL and 2RR to zero at a predetermined reduction gradient, and increasing the friction braking force of the four wheels 2FL, 2FR, 2RL, and 2RR by the amount corresponding to the regenerative braking force to be reduced.

In Step S15, it is determined whether or not the brake operation change amount falls below a second brake operation change amount threshold value. When the determination of “YES” is made, the process proceeds to Step S16, and when the determination of “NO” is made, the vehicle control device 17 repeats Step S15. The second brake operation change amount threshold value is a characteristic obtained by offsetting the characteristic of the first brake operation change amount threshold value shown in FIG. 6 to a plus side by a predetermined amount.

In Step S16, in the same manner as in Step S6, the vehicle control device 17 executes switching of the braking forces of reducing the increased friction braking force of the four wheels 2FL, 2FR, 2RL, and 2RR at a predetermined reduction gradient, and increasing the regenerative braking force of the rear wheels 2RL and 2RR by an amount corresponding to the friction braking force to be reduced, to thereby return a distribution of the total braking force of the vehicle to the regenerative braking force and the friction braking force to a distribution before the steering. At this time, the increase gradient of the regenerative braking force is set to be smaller in gradient (change rate) than the reduction gradient of the regenerative braking force in Step S4. Moreover, in the same manner as in Step S6, based on the map of FIG. 5, the rate of the increase in regenerative braking force with respect to the target braking force, that is, the switching rate, is changed in accordance with (the minimum value of) the stored estimated road surface u.

In Step S17, in the same manner as in Step S7, the estimation of the road surface μ is finished, and the estimated road surface μ is reset to a value corresponding to the high μ.

Actions and effects of the first embodiment are described next.

The electric vehicle is required to actively execute the regenerative braking through use of a drive source at the deceleration time in order to secure a cruising distance, to thereby recover energy to be lost at the braking time as electric power. Thus, in the rear-wheel-drive electric vehicle, only the rear wheels are often braked. Meanwhile, in a case in which the regenerative braking force of the rear wheels is increased particularly on a low u road, locking of the wheels is more liable to occur due to a decrease in lateral force of the rear wheels when the vehicle is turned during braking. Thus, the rear wheels are locked first, resulting in occurrence of an oversteering behavior. Due to those two backgrounds, the rear-wheel-drive electric vehicle has a problem in terms of its configuration in that an electric power regeneration amount at the deceleration time and vehicle stability at the turn time have a trade-off relationship.

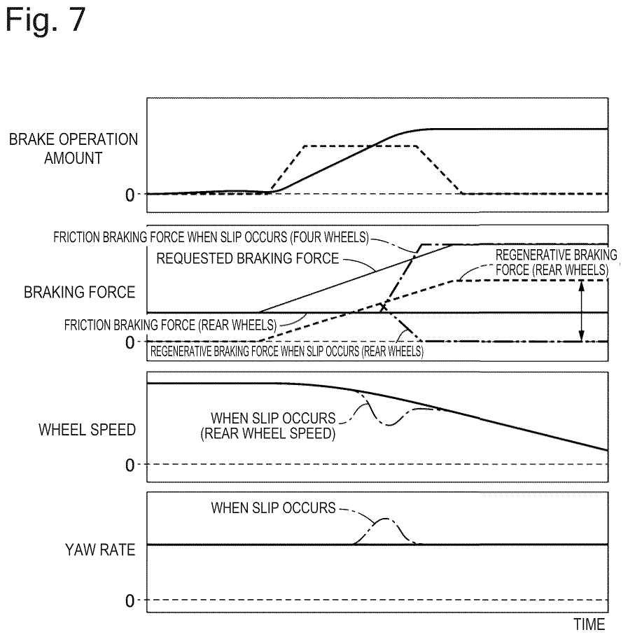

In order to solve the above-mentioned problem, as shown in FIG. 7, for a related-art electric vehicle, there has been known a method of, when the rear wheels slip during the turn and deceleration and thus a wheel speed difference between the front wheels and the rear wheels increases, reducing the regenerative braking force of the rear wheels, and increasing the friction braking force of the four wheels by an amount corresponding to the regenerative braking force to be reduced. However, the switchingping between the regenerative braking force and the friction braking force in this related art is a measure taken after the occurrence of the slips of the rear wheels, and hence it is difficult to increase the stability of the vehicle from an initial stage of the turn and deceleration of the vehicle.

In contrast, in the electric vehicle 1 in the first embodiment, when the vehicle is decelerated through use of the regenerative braking force of the rear wheels 2RL and 2RR, and the vehicle is turned, the regenerative braking force of the rear wheels 2RL and 2RR is reduced, and the friction braking force of the four wheels 2FL, 2FR, 2RL, and 2RR is increased by the amount corresponding to the regenerative braking force of the rear wheels 2RL and 2RR to be reduced. As a result, the locking of the rear wheels 2RL and 2RR can be suppressed, and hence the stability of the vehicle can be increased from the initial stage of the turn during the braking or the initial stage of the braking during the turn.

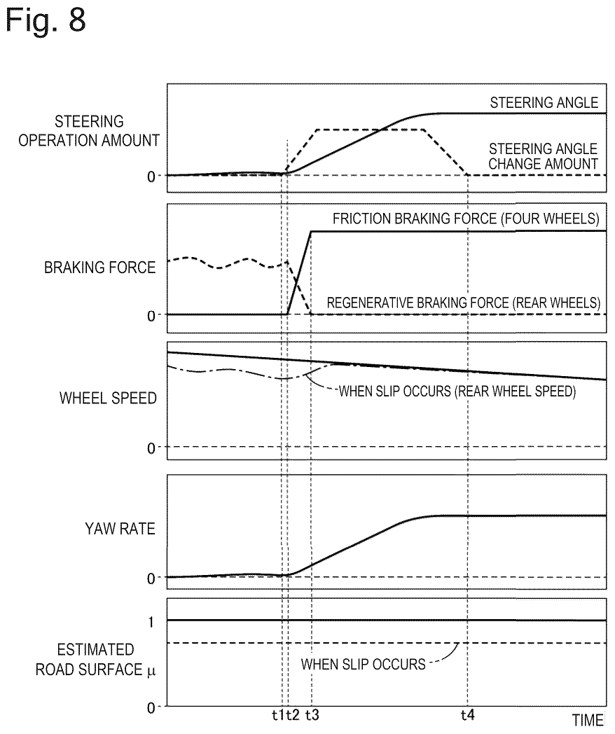

FIG. 8 is a time chart of a steering operation, the braking force, the wheel speed, the yaw rate, and the estimated road surface μ for illustrating an operation of the braking force switching control at the turn start time during the deceleration on the low p road in the vehicle control device 17 according to the first embodiment.

The driver starts steering at a time point t1, and the steering angle change amount exceeds the first steering angle change amount threshold value at a time point t2. Thus, the following switching of the braking forces is started: the regenerative braking force of the rear wheels 2RL and 2RR is reduced to zero at the predetermined reduction gradient, and the friction braking force of the four wheels 2FL, 2FR, 2RL, and 2RR is increased at a predetermined increase gradient by the amount corresponding to the regenerative braking force to be reduced. At a time point t3, the regenerative braking force of the rear wheels 2RL and 2RR becomes zero, and hence the deceleration is executed through use of only the friction braking force of the four wheels 2FL, 2FR, 2RL, and 2RR. Thus, the slip of the rear wheels 2RL and 2RR converges. As a result, it is possible to suppress the occurrence of the oversteering behavior from the initial stage of the turn.

At a time point t4, the steering angle change amount falls below the second steering angle change amount threshold value, but the electric vehicle 1 is traveling on the low u road. Thus, the switching of the braking forces from the friction braking force of the four wheels 2FL, 2FR, 2RL, and 2RR to the regenerative braking force of the rear wheels 2RL and 2RR is not executed. As a result, it is possible to prevent the lateral force of the rear wheels 2RL and 2RR from decreasing again during the low u road travel.

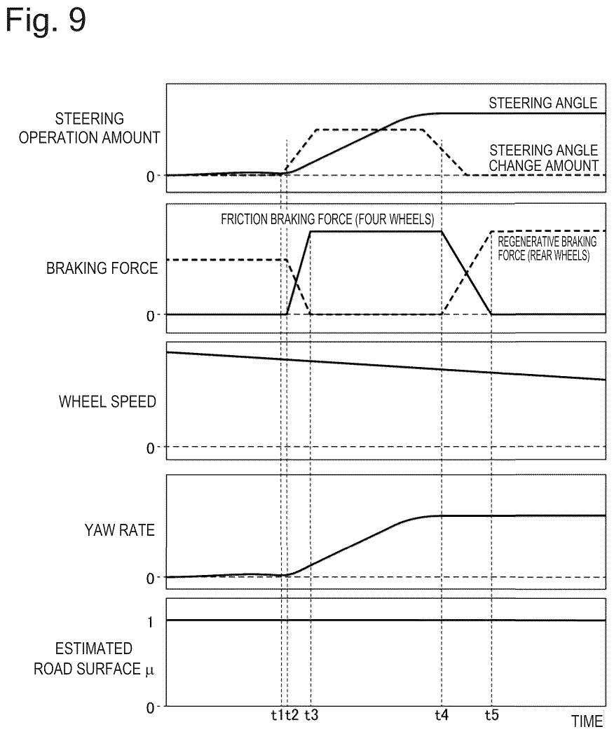

FIG. 9 is a time chart of the steering operation, the braking force, the wheel speed, the yaw rate, and the estimated road surface μ for illustrating the operation of the braking force switching control at the turn start time during the deceleration on the high u road in the vehicle control device 17 according to the first embodiment.

A section before the time point t4 is the same as that in the case of FIG. 8, and hence description thereof is omitted.

At the time point t4, the steering angle change amount falls below the second steering angle change amount threshold value, and the electric vehicle 1 is traveling on the high u road. Thus, the following switching of the braking forces is executed: the friction braking force of the four wheels 2FL, 2FR, 2RL, and 2RR is reduced at the predetermined reduction gradient (gradient smaller than the gradient at the increase time), and the regenerative braking force of the rear wheels 2RL and 2RR is increased at the predetermined reduction gradient (gradient smaller than the gradient at the reduction time) by the amount corresponding to the friction braking force to be reduced. In the related-art electric vehicle, as shown in FIG. 7, the regenerative braking force is inhibited after the regenerative braking force of the rear wheels is switchingped to the friction braking force of the four wheels. However, when the electric vehicle 1 is traveling on the high u road and the change amounts of the steering and the brake operation come to be considered as stable, even when the regenerative braking force of the rear wheels is increased, the oversteering behavior is less likely to occur. Thus, in this case, the electric energy recoverable through the regeneration during the turn can be increased through the switching from the friction braking force to the regenerative braking force compared with the related art.

At a time point 15, the friction braking force of the four wheels 2FL, 2FR, 2RL, and 2RR becomes zero, and the deceleration is executed through only the regenerative braking force of the rear wheels 2RL and 2RR.

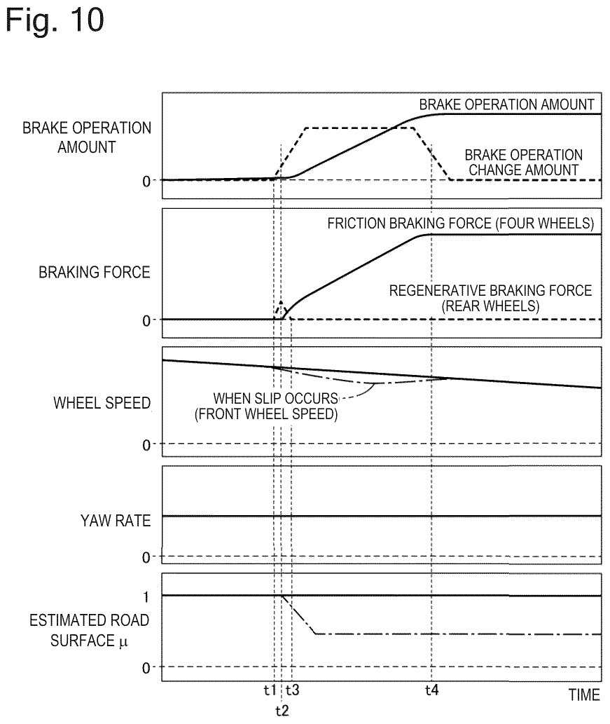

FIG. 10 is a time chart of a brake operation, the braking force, the wheel speed, the yaw rate, and the estimated road surface μ for illustrating the operation of the braking force switching control at the deceleration start time during the turn on the low u road in the vehicle control device 17 according to the first embodiment. It is premised that the steering angle is constant and that the vehicle is making a steady turn.

The driver starts the brake operation at the time point t1, and hence the regenerative braking force of the rear wheels 2RL and 2RR rises. The brake operation change amount exceeds the first brake operation change amount threshold value at the time point t2. Thus, the following switching of the braking forces is started: the regenerative braking force of the rear wheels 2RL and 2RR is reduced to zero at the predetermined reduction gradient, and the friction braking force of the four wheels 2FL, 2FR, 2RL, and 2RR is increased at the predetermined increase gradient by the amount corresponding to the regenerative braking force to be reduced. At the time point t3, the regenerative braking force of the rear wheels 2RL and 2RR becomes zero, and after the time point t3, only the friction braking force of the four wheels 2FL, 2FR, 2RL, and 2RR increases in response to the brake operation amount. As a result, the slip of the rear wheels 2RL and 2RR due to the decrease in lateral force is suppressed, and hence it is possible to suppress the occurrence of the oversteering behavior from an initial stage of the deceleration.

At the time point t4, the brake operation change amount falls below the second brake operation change amount threshold value, but the electric vehicle 1 is traveling on the low μ road. Thus, the switching of the braking forces from the friction braking force of the four wheels 2FL, 2FR, 2RL, and 2RR to the regenerative braking force of the rear wheels 2RL and 2RR is not executed. As a result, it is possible to prevent the lateral force of the rear wheels 2RL and 2RR from decreasing again during the low μ road travel.

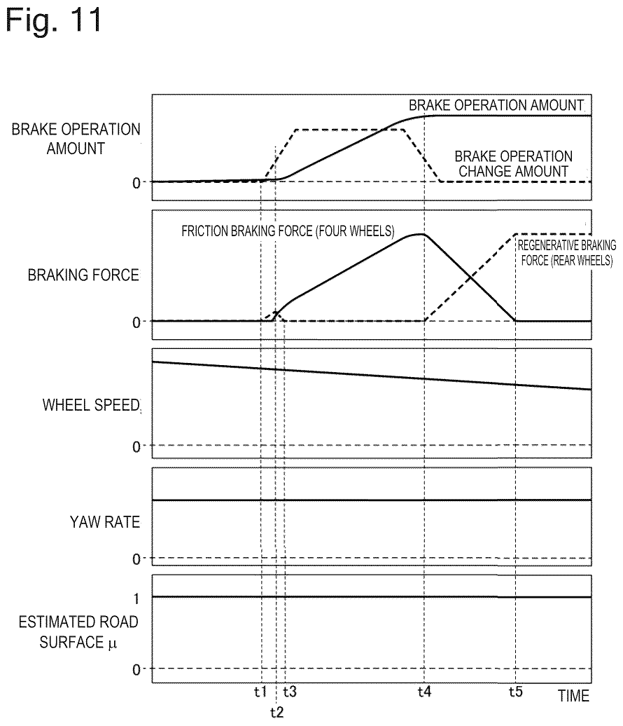

FIG. 11 is a time chart of the brake operation, the braking force, the wheel speed, the yaw rate, and the estimated road surface μ for illustrating the operation of the braking force switching control at the deceleration start time during the turn on the high u road in the vehicle control device 17 according to the first embodiment. It is premised that the steering angle is constant and that the vehicle is making a steady turn.

A section before the time point t4 is the same as that in the case of FIG. 10, and hence description thereof is omitted.

At the time point t4, the brake operation change amount falls below the second brake operation change amount threshold value, and the electric vehicle 1 is traveling on the high u road. Thus, the following switching of the braking forces is executed: the friction braking force of the four wheels 2FL, 2FR, 2RL, and 2RR is reduced at the predetermined reduction gradient (gradient smaller than the gradient at the increase time), and the regenerative braking force of the rear wheels 2RL and 2RR is increased at the predetermined increase gradient (gradient smaller than the gradient at the reduction time) by the amount corresponding to the friction braking force to be reduced. As a result, it is possible to suppress a decrease in electric power regeneration amount.

At a time point t5, the friction braking force of the four wheels 2FL, 2FR, 2RL, and 2RR becomes zero, and the deceleration is executed through only the regenerative braking force of the rear wheels 2RL and 2RR.

In the first embodiment, when the brake operation change amount exceeds the first brake operation change amount threshold value during the turn, the regenerative braking force of the rear wheels 2RL and 2RR is reduced and the friction braking force of the four wheels 2FL, 2FR, 2RL, and 2RR is increased by the amount corresponding to the regenerative braking force of the rear wheels 2RL and 2RR to be reduced. When the steering angle is constant, the behavior of the vehicle depends on the brake operation change amount, and when the brake operation change amount is large, the behavior of the vehicle is highly likely to become unstable. Thus, by executing the switching from the regenerative braking force to the friction braking force only when the brake operation change amount exceeds the first brake operation change amount threshold value, it is possible to suppress unnecessary restriction on the electric power recovery through the regeneration at the deceleration time.

The increase gradient of the regenerative braking force of the rear wheels 2RL and 2RR to be increased when the brake operation change amount falls below the second brake operation change amount threshold value is set to be smaller than the reduction gradient of the regenerative braking force of the rear wheels 2RL and 2RR to be reduced when the brake operation change amount exceeds the first brake operation change amount threshold value. When the brake operation change amount is changing, an occupant is less likely to feel the behavior change in vehicle due to the switching from the regenerative braking force to the friction braking force. Meanwhile, when the brake operation change amount is substantially constant, the occupant is more likely to feel the behavior change in vehicle due to the switching from the friction braking force to the regenerative braking force, which causes a sense of discomfort. Thus, by setting the reduction gradient and the increase gradient of the regenerative braking force as described above, it is possible to alleviate the sense of discomfort felt by the occupant at the time of the switching from the friction braking force to the regenerative braking force.

The reduction amount of the friction braking force of the four wheels 2FL, 2FR, 2RL, and 2RR to be reduced when the brake operation change amount falls below the second brake operation change amount threshold value is increased as the estimated road surface μ increases. When the brake operation change amount becomes stable and the switching is executed from the friction braking force to the regenerative braking force, the slips of the rear wheels 2RL and 2RR are likely to occur in the case in which the road surface μ is low and the slips are less likely to occur in the case in which the road surface μ is high. Thus, by increasing the regenerative braking force to be increased as the road surface μ is higher, it is possible to simultaneously achieve the suppression of the oversteering behavior and the increase in electric power regeneration amount at the deceleration time.

The first brake operation change amount threshold value is set to be larger as the lateral G of the vehicle decreases. The oversteering behavior is less likely to occur as the lateral G is lower, and hence, by increasing the first brake operation change amount threshold value as the lateral G is lower, it is possible to suppress unnecessary restriction on the electric power recovery through the regeneration at the deceleration time.

In the first embodiment, when the steering angle change amount exceeds the first steering angle change amount threshold value during the deceleration of the vehicle through the regenerative braking force of the rear wheels 2RL and 2RR, the regenerative braking force of the rear wheels 2RL and 2RR is reduced, and the friction braking force of the four wheels 2FL, 2FR, 2RL, and 2RR is increased by the amount corresponding to the regenerative braking force of the rear wheels 2RL and 2RR to be reduced. When the deceleration is constant, the behavior of the vehicle depends on the steering angle change amount, and when the steering angle change amount is large, the behavior of the vehicle is highly likely to become unstable. Thus, by executing the switching from the regenerative braking force to the friction braking force only when the steering angle change amount exceeds the first steering angle change amount threshold value, it is possible to suppress unnecessary restriction on the electric power recovery through the regeneration at the deceleration time.

The increase gradient of the regenerative braking force of the rear wheels 2RL and 2RR to be increased when the steering angle change amount falls below the second steering angle change amount threshold value is set to be smaller than the reduction gradient of the regenerative braking force of the rear wheels 2RL and 2RR to be reduced when the steering angle change amount exceeds the first steering angle change amount threshold value. When the steering angle change amount is changing, the occupant is less likely to feel the behavior change in the vehicle due to the switching from the regenerative braking force to the friction braking force. Meanwhile, when the steering angle change amount is substantially constant, the occupant is more likely to feel the behavior change in the vehicle due to the switching from the friction braking force to the regenerative braking force, which causes a sense of discomfort. Thus, by setting the reduction gradient and the increase gradient of the regenerative braking force as described above, it is possible to alleviate the sense of discomfort felt by the occupant at the time of the switching from the friction braking force to the regenerative braking force.

The first steering angle change amount threshold value is set to be larger as the speed of the vehicle decreases. The oversteering behavior is less likely to occur as the vehicle speed is lower, and hence, by increasing the first steering angle change amount threshold value as the vehicle speed is lower, it is possible to suppress unnecessary restriction on the electric power recovery through the regeneration at the deceleration time.

### Second Embodiment

A basic configuration of a second embodiment of the present invention is the same as that of the first embodiment, and hence description is given of only differences from the first embodiment.

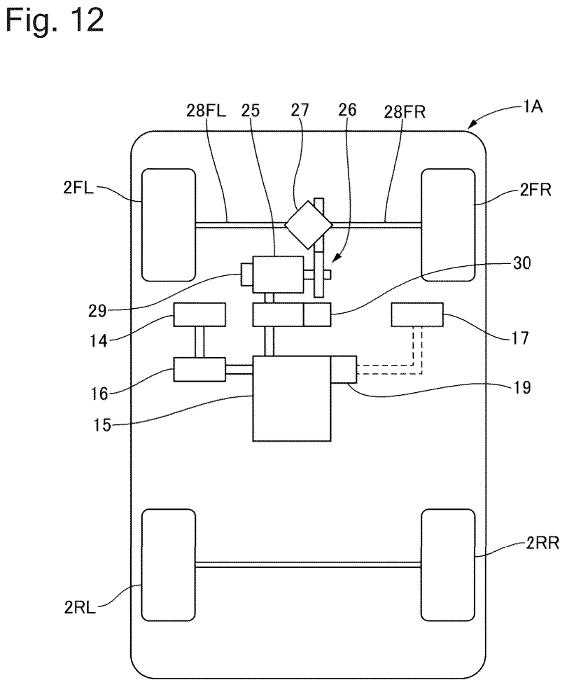

FIG. 12 is a schematic diagram of a powertrain of an electric vehicle 1A including a vehicle control system according to the second embodiment.

The electric vehicle 1A includes a front motor generator (a regenerative braking device and a drive device, and hereinafter referred to as “front motor”) 25 which outputs torques to the front wheels 2FL and 2FR. The front wheels 2FL and 2FR are driving wheels and regenerative wheels. A power transmission between the front motor 25 and the front wheels 2FL and 2FR is executed through a speed reducer 26, a differential 27, and front axles 28FL and 28FR. The front motor 25 includes a front wheel resolver 29 which detects a motor speed (motor rotation number).

The vehicle control device 17 acquires information from various sensors such as the front wheel resolver 29, to thereby execute integrated control for the vehicle. The vehicle control device 17 sets the target driving force in accordance with the accelerator operation of the driver and the like, and outputs the driving torque command for achieving the target driving force to the front motor control device 30. Moreover, the vehicle control device 17 sets the target braking force in accordance with the brake operation of the driver and the like, and outputs a regenerative torque command for achieving the target braking force to the front motor control device 30.

The front motor control device 30 controls electric power to be supplied to the front motor 25 based on the driving torque command or the regenerative torque command.

Other configurations are the same as those in the first embodiment illustrated in FIG. 1.

In the electric vehicle 1A in the second embodiment, the following switching of the braking forces is executed. The switching of the braking forces aims to increase the stability of the vehicle at the turn and deceleration time, and, when the vehicle is decelerated through use of the regenerative braking force of the front wheels 2FL and 2FR and the vehicle is turned, reduces the regenerative braking force of the front wheels 2FL and 2FR, and increases the friction braking force of each of the wheels 2FL, 2FR, 2RL, and 2RR by an amount corresponding to the regenerative braking force to be reduced.

The flow of the braking force switching control processing in the second embodiment is the same as the braking force switching control processing at the turn start time during the deceleration and the braking force switching control processing at the deceleration start time during the turn in the first embodiment illustrated in FIG. 2 and FIG. 3, respectively. In the second embodiment, the processing steps of Step S4 and Step S6 of FIG. 2 and Step S14 and Step S16 of FIG. 3 performed for the rear wheels 2RL and 2RR is replaced by processing performed for the front wheels 2FL and 2FR, and is applied.

Actions and effects of the second embodiment are described next.

In the front-wheel-drive electric vehicle, only the front wheels are often braked, hence, in a case in which the regenerative braking force of the front wheels is increased particularly on the low μ road, the locking of the wheels is likely to occur due to the decrease in lateral force of the front wheels when the vehicle is turned during braking. Thus, the front wheels are locked first, resulting in occurrence of an understeering behavior.

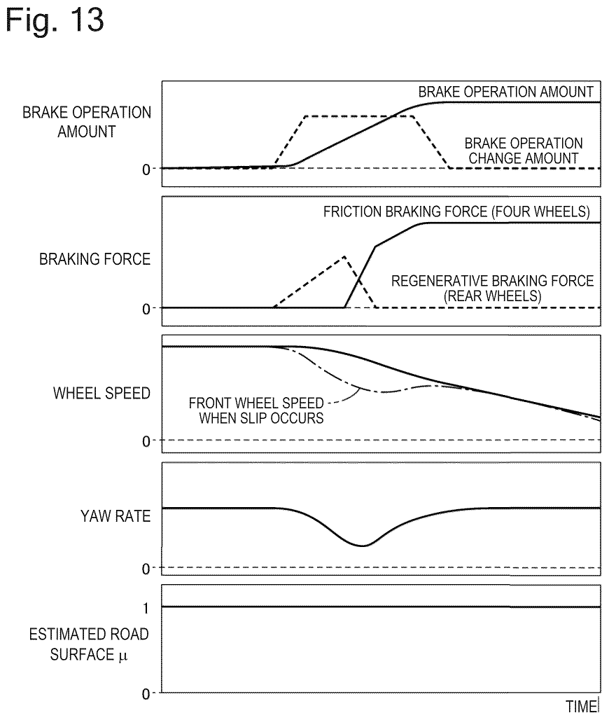

In a related-art electric vehicle, as shown in FIG. 13, until the front wheels slip during the turn and deceleration and thus the wheel speed difference between the front and rear wheels increases, the switching from the regenerative braking forces of the front wheels to the friction braking force of the four wheels is not started. Thus, it has been difficult to suppress the understeering behavior from a braking initial stage during the turn.

In contrast, in the electric vehicle 1A in the second embodiment, when the vehicle is decelerated through use of the regenerative braking force of the front wheels 2FL and 2FR and the vehicle is turned, the regenerative braking force of the front wheels 2FL and 2FR is reduced, and the friction braking force of the four wheels 2FL, 2FR, 2RL, and 2RR is increased by the amount corresponding to the regenerative braking force of the front wheels 2FL and 2FR to be reduced. As a result, the locking of the front wheels 2FL and 2FR can be suppressed, and hence the stability of the vehicle can be increased from the initial stage of the turn during the braking or the initial stage of the braking during the turn.

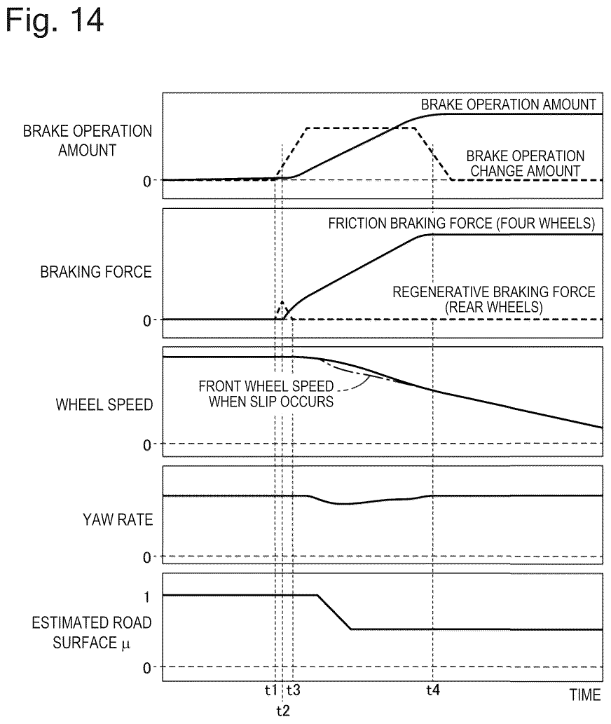

FIG. 14 is a time chart of the brake operation, the braking force, the wheel speed, the yaw rate, and the estimated road surface μ for illustrating the operation of the braking force switching control at the deceleration start time during the turn on the low p road in the vehicle control device 17 according to the second embodiment. It is premised that the steering angle is constant and that the vehicle is making a steady turn.

The driver starts the brake operation at the time point t1, and hence the regenerative braking force of the front wheels 2FL and 2FR rises. The brake operation change amount exceeds the first brake operation change amount threshold value at the time point 12. Thus, the following switching of the braking forces is started: the regenerative braking force of the front wheels 2FL and 2FR is reduced to zero at a predetermined reduction gradient, and the friction braking force of the four wheels 2FL, 2FR, 2RL, and 2RR is increased at a predetermined increase gradient by the amount corresponding to the regenerative braking force to be reduced. At the time point t3, the regenerative braking force of the front wheels 2FL and 2FR becomes zero, and after the time point t3, only the friction braking force of the four wheels 2FL, 2FR, 2RL, and 2RR increases in response to the brake operation amount. As a result, the slip of the front wheels 2FL and 2FR due to the decrease in lateral force is suppressed, and hence it is possible to suppress the occurrence of the oversteering behavior from the initial stage of the deceleration.

At the time point t4, the brake operation change amount falls below the second brake operation change amount threshold value, but the electric vehicle 1A is traveling on the low μ road. Thus, the switching of the braking forces from the friction braking force of the four wheels 2FL, 2FR, 2RL, and 2RR to the regenerative braking force of the front wheels 2FL and 2FR is not executed. As a result, it is possible to prevent the lateral force of the front wheels 2FL and 2FR from decreasing again during the low μ road travel.

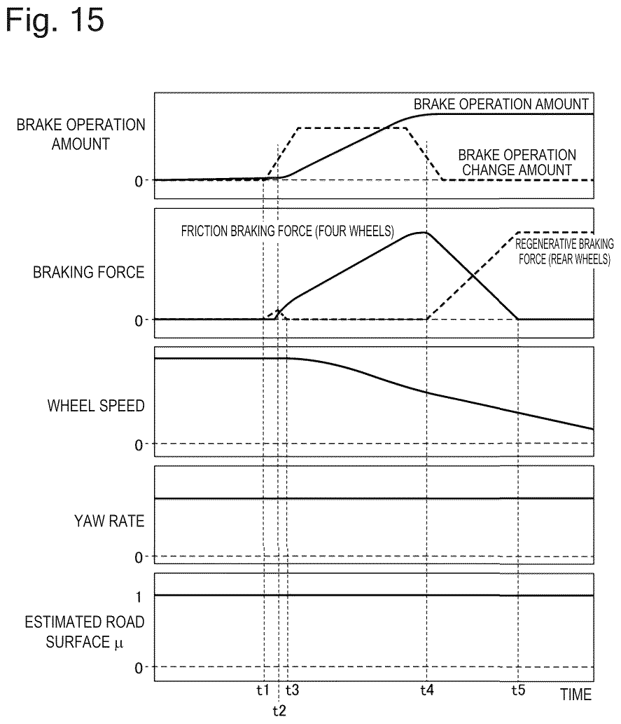

FIG. 15 is a time chart of the brake operation, the braking force, the wheel speed, the yaw rate, and the estimated road surface μ for illustrating the operation of the braking force switching control at the deceleration start time during the turn on the high p road in the vehicle control device 17 according to the second embodiment. It is premised that the steering angle is constant and that the vehicle is making a steady turn.

A section before the time point t4 is the same as that in the case of FIG. 14, and hence description thereof is omitted.

At the time point 14, the brake operation change amount falls below the second brake operation change amount threshold value, and the electric vehicle 1A is traveling on the high u road. Thus, the following switching of the braking forces is executed: the friction braking force of the four wheels 2FL, 2FR, 2RL, and 2RR is reduced at a predetermined reduction gradient (gradient smaller than the gradient at the increase time), and the regenerative braking force of the front wheels 2FL and 2FR is increased at a predetermined increase gradient (gradient smaller than the gradient at the reduction time) by an amount corresponding to the friction braking force to be reduced. As a result, it is possible to suppress a decrease in electric power regeneration amount.

At the time point 15, the friction braking force of the four wheels 2FL, 2FR, 2RL, and 2RR becomes zero, and the deceleration is executed through only the regenerative braking force of the front wheels 2FL and 2FR.

As described above, the electric vehicle 1A in the second embodiment achieves the same actions and effects as those in the first embodiment.

### Third Embodiment

A basic configuration of a third embodiment of the present invention is the same as that of the first embodiment or the second embodiment, and hence description is given of only differences from the first embodiment or the second embodiment.

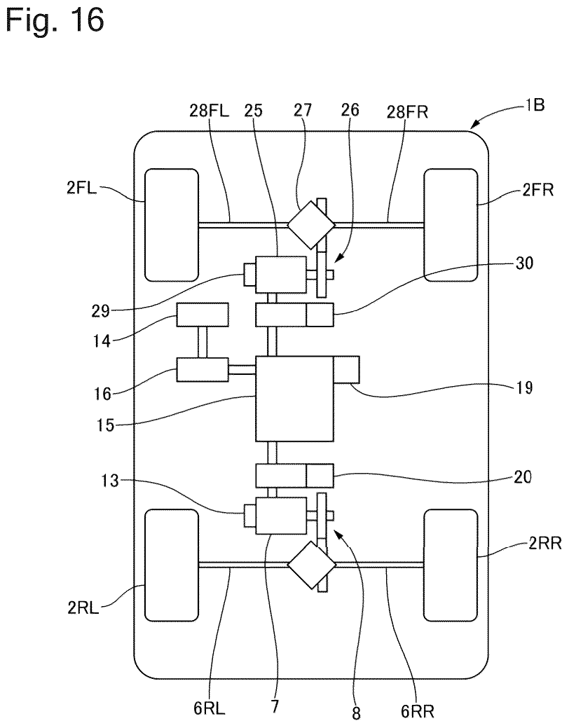

FIG. 16 is a schematic diagram of a powertrain of an electric vehicle 1B including a vehicle control system according to the third embodiment.

The electric vehicle 1B includes the rear motor 7 which outputs torques to the rear wheels 2RL and 2RR and the front motor 25 which outputs torques to the front wheels 2FL and 2FR. The front wheels 2FL and 2FR and the rear wheels 2RL and 2RR are driving wheels and regenerative wheels.

The vehicle control device 17 acquires information from various sensors such as the rear wheel resolver 13, the front wheel resolver 29, the accelerator pedal sensor 22 which detects the accelerator operation amount, the brake sensor 23 which detects the brake operation amount, and the steering angle sensor 24 which detects the steering angle of the steering wheel (not shown), to thereby execute the integrated control for the vehicle. The vehicle control device 17 sets the target driving force in accordance with the accelerator operation of the driver and the like, and outputs the driving torque command for achieving the target driving force to the rear motor control device 20 and the front motor control device 30. Moreover, the vehicle control device 17 sets the target braking force in accordance with the brake operation of the driver and the like, and outputs the regenerative torque command for achieving the target braking force to the rear motor control device 20 and the front motor control device 30. The distribution of the regenerative braking force to the front wheels and the rear wheels is set as, for example, front wheels: rear wheels=6:4.

Other configurations are the same as those in the first embodiment illustrated in FIG. 1 or the second embodiment illustrated in FIG.

In the electric vehicle 1B in the third embodiment, the following switching of the braking forces is executed. The switching of the braking forces aims to increase the stability of the vehicle at the turn and deceleration time, and, when the vehicle is decelerated through use of the regenerative braking force of the four wheels 2FL, 2FR, 2RL, and 2RR and the vehicle is turned, reduces the regenerative braking force of the rear wheels 2RL and 2RR, and increases the regenerative braking force of the front wheels 2FL and 2FR by an amount corresponding to the regenerative braking force of the rear wheels 2RL and 2RR to be reduced.

The braking force switching control processing in the third embodiment is the same as the braking force switching control processing at the turn start time during the deceleration and the braking force switching control processing at the deceleration start time during the turn in the first embodiment illustrated in FIG. 2 and FIG. 3, respectively. Only differences are now described.

In Step S4 and Step S14, the following switching of the braking forces is executed: the regenerative braking force of the rear wheels 2RL and 2RR is reduced and the regenerative braking force of the front wheels 2FL and 2FR is increased by the amount corresponding to the regenerative braking force of the rear wheels 2RL and 2RR to be reduced so that the distribution of the regenerative braking force to the front wheels and the rear wheels is, for example, 2:8 or 1:9.

In Step S6 and Step S16, the following switching of the braking forces is executed: the increased regenerative braking force of the front wheels 2FL and 2FR is reduced, and the regenerative braking force of the rear wheels 2RL and 2RR is increased by an amount corresponding to the regenerative braking force of the front wheels 2FL and 2FR to be reduced, to thereby return the distribution of the regenerative braking force to the front wheels and the rear wheels to a distribution (6:4) before the steering.

Actions and effects of the third embodiment are described next.

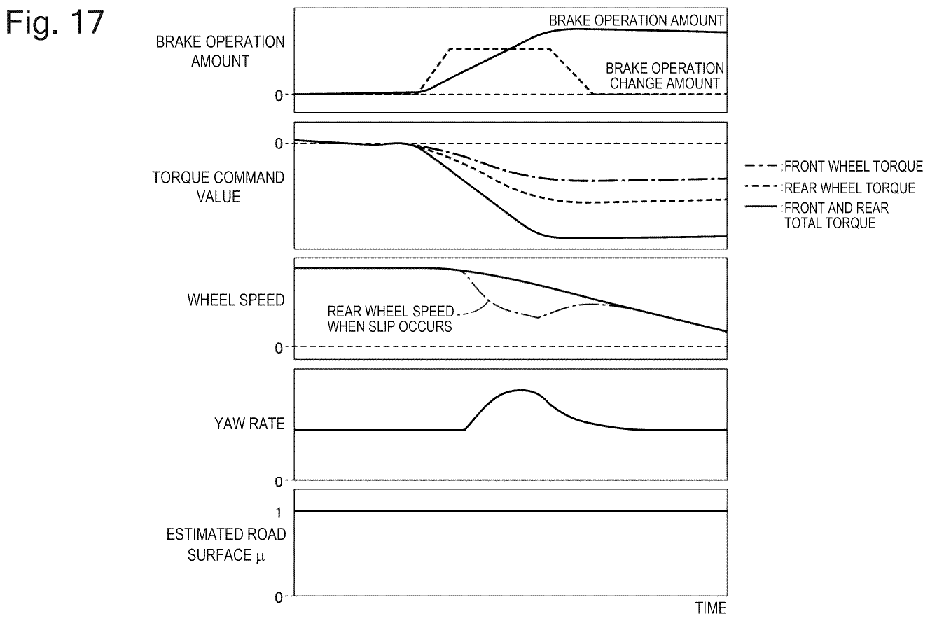

The regenerative braking force is generated by the front wheels and the rear wheels at the braking time in a four-wheel-drive electric vehicle, and the center of gravity of the vehicle moves toward the front wheel side particularly at the turn and deceleration time on the low μ road. Thus, as shown in FIG. 17, the locking of the wheels is likely to occur due to the decrease in lateral force of the rear wheels, and hence the rear wheels are locked first, resulting in the occurrence of the oversteering behavior.

In view of the above, in the electric vehicle 1B in the third embodiment, when the vehicle is decelerated through use of the regenerative braking force of both of the front wheels 2FL and 2FR and the rear wheels 2RL and 2RR and the vehicle is turned, the regenerative braking force of the rear wheels 2RL and 2RR is reduced, and the regenerative braking force of the front wheels 2FL and 2FR is increased by the amount corresponding to the regenerative braking force of the rear wheels 2RL and 2RR to be reduced. As a result, the locking of the rear wheels 2RL and 2RR can be suppressed, and hence the stability of the vehicle can be increased from the initial stage of the turn during the braking or the initial stage of the braking during the turn.

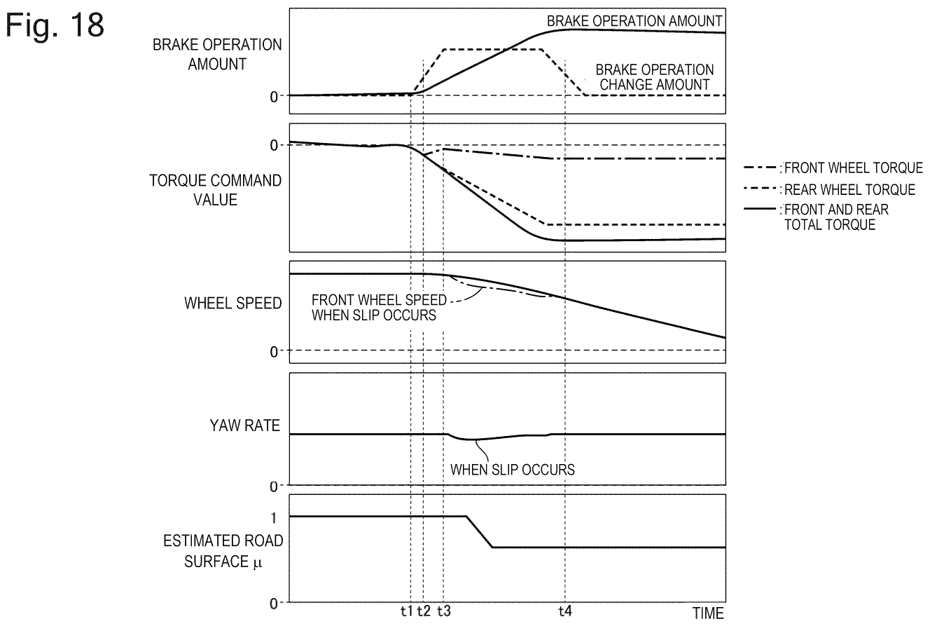

FIG. 18 is a time chart of the brake operation, the torque command, the wheel speed, the yaw rate, and the estimated road surface μ for illustrating the operation of the braking force switching control at the deceleration start time during the turn on the low μ road in the vehicle control device 17 according to the third embodiment. It is premised that the steering angle is constant and that the vehicle is making a steady turn.

The driver starts the brake operation at the time point t1, and hence the regenerative braking force of the front and rear wheels rises. The brake operation change amount exceeds the first brake operation change amount threshold value at the time point t2. Thus, the following switching of the braking forces is started: the regenerative braking force of the rear wheels 2RL and 2RR is reduced at a predetermined reduction gradient, and the regenerative braking force of the front wheels 2FL and 2FR is increased at a predetermined increase gradient by the amount corresponding to the regenerative braking force of the rear wheels 2RL and 2RR to be reduced. At the time point t3, the distribution of the regenerative braking force to the front wheels and the rear wheels is 9:1.

At the time point t4, the brake operation change amount falls below the second brake operation change amount threshold value, but the electric vehicle 1B is traveling on the low μ road. Thus, the switching of the braking forces of reducing the regenerative braking force of the front wheels 2FL and 2FR and increasing the regenerative braking force of the rear wheels 2RL and 2RR is not executed. As a result, it is possible to prevent the lateral force of the rear wheels 2RL and 2RR from decreasing again during the low μ road travel.

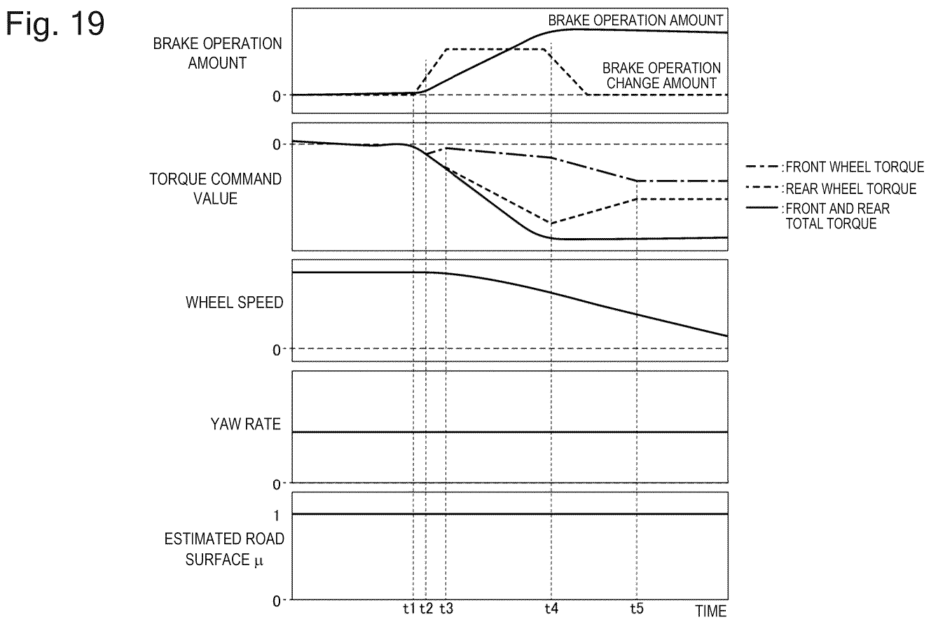

FIG. 19 is a time chart of the brake operation, the torque command, the wheel speed, the yaw rate, and the estimated road surface μ for illustrating the operation of the braking force switching control at the deceleration start time during the turn on the high u road in the vehicle control device 17 according to the third embodiment. It is premised that the steering angle is constant and that the vehicle is making a steady turn.

A section before the time point t4 is the same as that in the case of FIG. 18, and hence description thereof is omitted.

At the time point t4, the brake operation change amount falls below the second brake operation change amount threshold value, and the electric vehicle 1B is traveling on the high u road. Thus, the following switching of the braking forces is executed: the regenerative braking force of the front wheels 2FL and 2FR is reduced at a predetermined reduction gradient, and the regenerative braking force of the rear wheels 2RL and 2RR is increased at a predetermined increase gradient by an amount corresponding to the regenerative braking force of the front wheels 2FL and 2FR to be reduced. As a result, it is possible to suppress a decrease in electric power regeneration amount.

At the time point t5, the distribution of the regenerative braking force to the front wheels and the rear wheels returns to the distribution (6:4) before the brake operation.

### Fourth Embodiment

A basic configuration of a fourth embodiment of the present invention is the same as that of the third embodiment, and hence description is given of only differences from the third embodiment.

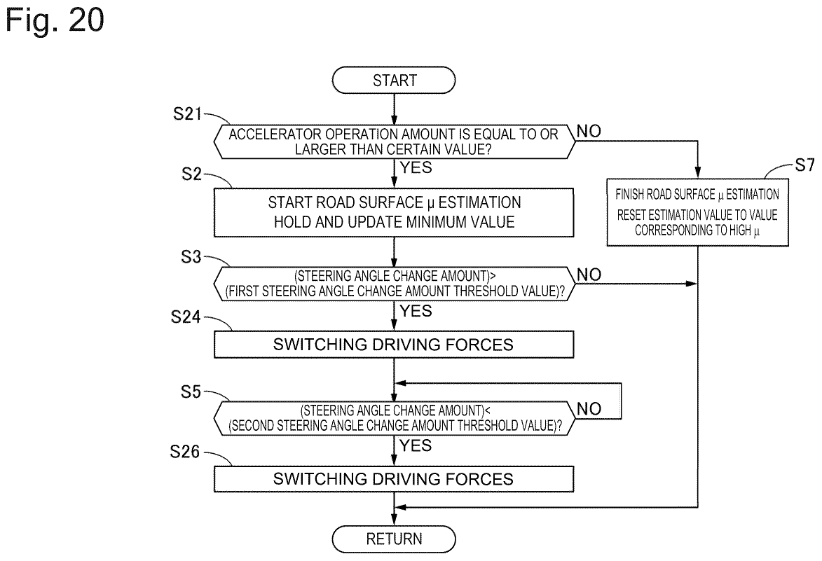

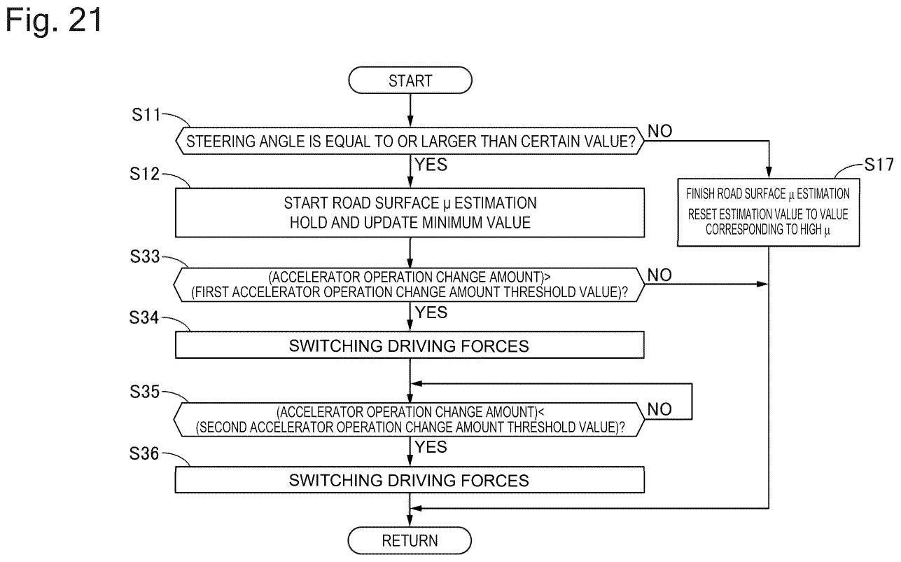

In the electric vehicle 1B in the fourth embodiment, the following switching of driving forces is executed. The switching of driving forces aims to increase the stability of the vehicle at a turn acceleration time, and, when the vehicle is accelerated through use of a driving force of both of the front wheels 2FL and 2FR and the rear wheels 2RL and 2RR of the vehicle and the vehicle is turned, reduces the driving force of the rear wheels 2RL and 2RR, and increases the driving force of the front wheels 2FL and 2FR by an amount corresponding to the driving force of the rear wheels 2RL and 2RR to be reduced. Here, “reduces the driving force of the rear wheels 2RL and 2RR” means not only reducing the current driving force of the rear wheels 2RL and 2RR, but also setting an upper limit to the driving force of the rear wheels 2RL and 2RR. FIG. 20 and FIG. 21 are flowcharts for illustrating flows of driving force switching control processing by the vehicle control device 17 according to the fourth embodiment. The flowcharts illustrated in FIG. 20 and FIG. 21 are repeatedly executed in parallel at a predetermined control cycle while the vehicle is active. The flowchart of FIG. 20 is first described.

FIG. 20 is a flowchart for illustrating the flow of the driving force switching control processing at the turn start time during the acceleration in the vehicle control device 17 in the fourth embodiment of the present invention. Steps in which the same processing as that of the flowchart of FIG. 2 is executed are denoted by the same step numbers, and description thereof is omitted.

In Step S21, the vehicle control device 17 determines whether or not the accelerator operation amount is equal to or larger than a certain value. When the determination of “YES” is made, the process proceeds to Step S22, and when the determination of “NO” is made, the process proceeds to Step S27.

In Step S24, the vehicle control device 17 executes the switching of the driving forces of reducing the driving force of the rear wheels 2RL and 2RR and increasing the driving force of the front wheels 2FL and 2FR by the amount corresponding to the driving force of the rear wheels 2RL and 2RR to be reduced.

In Step S26, the vehicle control device 17 executes switching of the driving forces of reducing the increased driving force of the front wheels 2FL and 2FR and increasing the driving force of the rear wheels 2RL and 2RR by an amount corresponding to the driving force of the front wheels 2FL and 2FR to be reduced. At this time, in the same manner as in Step S6, based on FIG. 5, the rate of the increase in driving force of the rear wheels 2RL and 2RR, that is, the switching rate, is changed in accordance with (the minimum value of) the stored estimated road surface u.

The flowchart of FIG. 21 is described next. FIG. 21 is a flowchart for illustrating the flow of the driving force switching control processing at the acceleration start time during the turn in the vehicle control device 17 in the fourth embodiment. Steps in which the same processing as that of the flowchart of FIG. 3 is executed are denoted by the same step numbers, and description thereof is omitted.

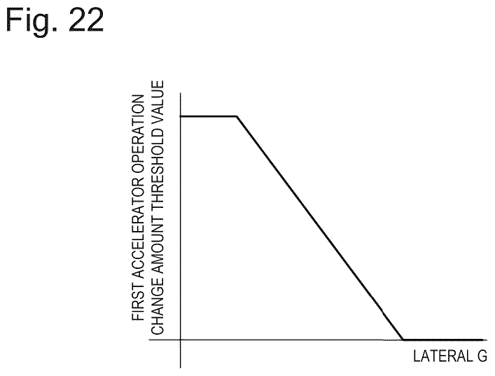

In Step S33, the vehicle control device 17 determines whether or not an accelerator operation change amount being a derivative of the accelerator operation amount exceeds a first accelerator operation change amount threshold value. When the determination of “YES” is made, the process proceeds to Step S14, and when the determination of “NO” is made, the process proceeds to “RETURN.” FIG. 22 is a setting map for the first accelerator operation change amount threshold value in accordance with the lateral G in the first embodiment. The map of FIG. 22 is set such that the first accelerator operation change amount threshold value decreases as the lateral G increases. The first accelerator operation change amount threshold value takes the maximum value in the low lateral G region in which the turning inner wheel does not slip and takes the minimum value in the high lateral G region in which the turning inner wheel slips.

In Step S34, in the same manner as in Step S24, the vehicle control device 17 executes the switching of the driving forces of reducing the driving force of the rear wheels 2RL and 2RR and increasing the driving force of the front wheels 2FL and 2FR by the amount corresponding to the driving force of the rear wheels 2RL and 2RR to be reduced.

In Step S35, the vehicle control device 17 determines whether or not the accelerator operation change amount falls below the second accelerator operation change amount threshold value. When the determination of “YES” is made, the process proceeds to Step S36, and when the determination of “NO” is made, the vehicle control device 17 repeats Step S35. The second accelerator operation change amount threshold value is a characteristic obtained by offsetting the characteristic of the first accelerator operation change amount threshold value shown in FIG. 21 to a plus side by a predetermined amount.

In Step S36, in the same manner as in Step S26, the vehicle control device 17 executes switching of the driving forces of reducing the increased driving force of the front wheels 2FL and 2FR and increasing the driving force of the rear wheels 2RL and 2RR by an amount corresponding to the driving force of the front wheels 2FL and 2FR to be reduced. At this time, in the same manner as in Step S26, based on the map of FIG. 5, the rate of the increase in regenerative braking force with respect to the target braking force, that is, the switching rate, is changed in accordance with (the minimum value of) the stored estimated road surface u.

Actions and effects of the fourth embodiment are described next.

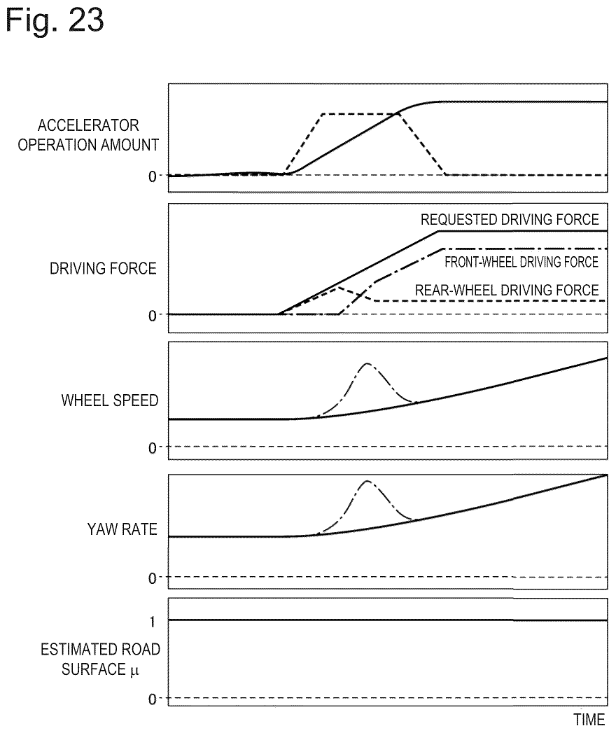

In the four-wheel-drive electric vehicle, the center of gravity of the vehicle moves toward the rear wheel side at the acceleration time, and hence the driving force is generated only on the rear wheels in normal cases. In the related-art electric vehicle, as shown in FIG. 23, when the wheel speed difference between the front wheels and the rear wheels becomes large, the driving force of the front wheels is generated, and the driving force of the rear wheels is reduced, to thereby suppress the oversteering behavior. However, this is a measure taken after the occurrence of the slip of the rear wheels, hence it is difficult to increase the stability of the vehicle from an initial stage of the turn and acceleration of the vehicle.

In contrast, in the fourth embodiment, when the vehicle is accelerated through use of the driving force of both of the front wheels 2FL and 2FR and the rear wheels 2RL and 2RR of the vehicle and the vehicle is turned, the driving force of the rear wheels 2RL and 2RR is reduced, and the driving force of the front wheels 2FL and 2FR is increased by the amount corresponding to the driving force of the rear wheels 2RL and 2RR to be reduced. As a result, the stability of the vehicle can be increased from the initial stage of the turn during the acceleration or the initial stage of the acceleration during the turn.

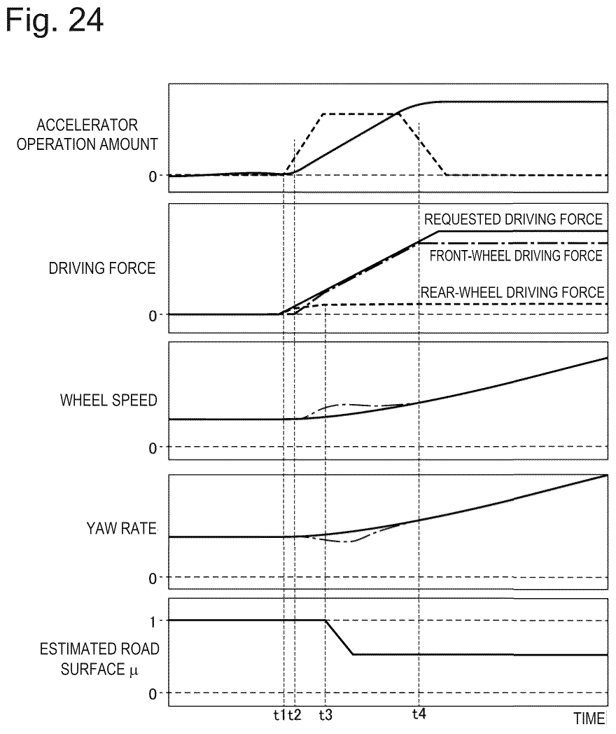

FIG. 24 is a time chart of the accelerator operation, the driving force, the wheel speed, the yaw rate, and the estimated road surface μ for illustrating the operation of the driving force switching control at the acceleration start time during the turn on the low p road in the vehicle control device 17 according to the fourth embodiment. It is premised that the steering angle is constant and that the vehicle is making a steady turn.

The driver starts the accelerator operation at the time point t1, and hence the driving force of the rear wheels 2RL and 2RR rises. The accelerator operation change amount exceeds the first accelerator operation change amount threshold value at the time point t2. Thus, the switching of the driving forces of reducing the driving force of the rear wheels 2RL and 2RR and increasing the driving force of the front wheels 2FL and 2FR by the amount corresponding to the driving force of the rear wheels 2RL and 2RR to be reduced is started. At the time point t3, the driving force of the rear wheels 2RL and 2RR reaches the upper limit.

At the time point t4, the accelerator operation change amount falls below the second accelerator operation change amount threshold value, but the electric vehicle 1B is traveling on the low μ road. Thus, the switching of the driving forces of reducing the driving force of the front wheels 2FL and 2FR and increasing the driving force of the rear wheels 2RL and 2RR is not executed. As a result, it is possible to prevent the lateral force of the rear wheels 2RL and 2RR from decreasing again during the low μ road travel.

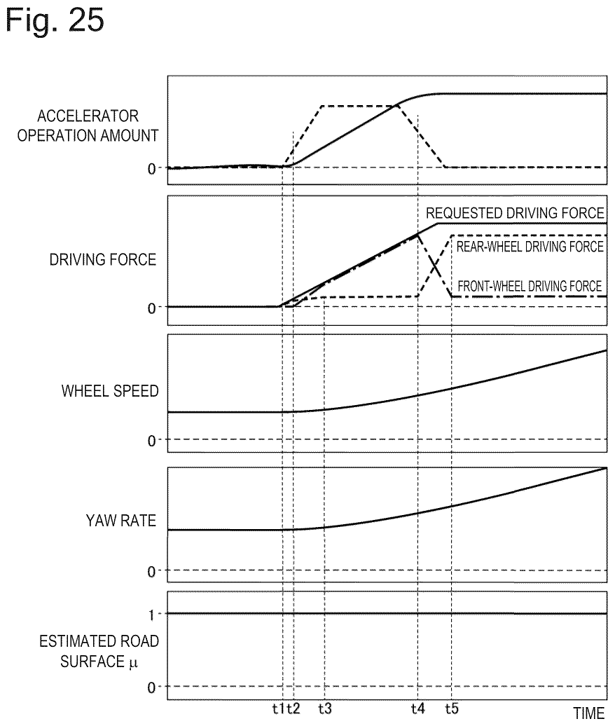

FIG. 25 is a time chart of the accelerator operation, the driving force, the wheel speed, the yaw rate, and the estimated road surface μ for illustrating the operation of the braking force switching control at the deceleration start time during the turn on the high u road in the vehicle control device 17 according to the fourth embodiment. It is premised that the steering angle is constant and that the vehicle is making a steady turn.

A section before the time point t4 is the same as that in the case of FIG. 18, and hence description thereof is omitted.

At the time point t4, the accelerator operation change amount falls below the second accelerator operation change amount threshold value, and the electric vehicle 1B is traveling on the high p road. Thus, the switching of the driving forces of reducing the driving force of the front wheels 2FL and 2FR and increasing the driving force of the rear wheels 2RL and 2RR by an amount corresponding to the driving force of the front wheels 2FL and 2FR to be reduced is executed.

At the time point t5, the distribution of the driving force to the front wheels and the rear wheels returns to the distribution before the accelerator operation.

### OTHER EMBODIMENTS

The embodiment of the present invention has been described above. However, the specific configuration of the present invention is not limited to the configuration of the embodiment. A modification in design and the like without departing from the gist of the invention are also encompassed in the present invention.

For example, in the embodiment, the example in which the regenerative braking force is reduced to zero has been described, but the regenerative braking force may be reduced to a predetermined value larger than zero.

Note that, the present invention is not limited to the above-mentioned embodiment, and includes further various modification examples. For example, in the above-mentioned embodiment, the configurations are described in detail in order to clearly describe the present invention, but the present invention is not necessarily limited to an embodiment that includes all the configurations that have been described. Further, a part of the configuration of a given embodiment can replace the configuration of another embodiment, and the configuration of another embodiment can also be added to the configuration of a given embodiment. Further, another configuration can be added to, deleted from, or replace a part of the configuration of each of the embodiments.

The present application claims a priority based on Japanese Patent Application No. 2023-008009 filed on Jan. 23, 2023. All disclosed contents including Specification, Scope of Claims, Drawings, and Abstract of Japanese Patent Application No. 2023-008009 filed on Jan. 23, 2023 are incorporated herein by reference in their entirety.

### REFERENCE SIGNS LIST

1 . . . electric vehicle (vehicle), 2FL, 2FR . . . front wheel, 2RL, 2RR . . . rear wheel, 3 . . . friction brake (friction braking device), 7 . . . rear motor (regenerative braking device, driving device), 17 . . . vehicle control device (control part)

1. A vehicle control device, which is included in a vehicle including a friction braking device configured to generate a friction braking force on the vehicle and a regenerative braking device configured to generate a regenerative braking force on the vehicle, the vehicle control device comprising a control part,
wherein the control part is configured to output a control command to:
in a case in which the vehicle is to be decelerated through a regenerative braking force of a regenerative wheel being any one of a front wheel or a rear wheel of the vehicle, when the vehicle is turned, reduce the regenerative braking force of the regenerative wheel from a regenerative braking force at a time when the vehicle is not turned, and increase the friction braking force by an amount corresponding to the regenerative braking force of the regenerative wheel to be reduced; or
in a case in which the vehicle is to be decelerated through a regenerative braking force of both of the front wheel and the rear wheel of the vehicle, when the vehicle is turned, reduce the regenerative braking force of the rear wheel from a regenerative braking force at the time when the vehicle is not turned, and increase the regenerative braking force of the front wheel by an amount corresponding to the regenerative braking force of the rear wheel to be reduced.

2. The vehicle control device according to claim 1,
wherein the regenerative wheel is the rear wheel of the vehicle, and
wherein the control command is a command to, in a case in which the vehicle is to be decelerated through the regenerative braking force of the rear wheel of the vehicle, when the vehicle is turned, reduce the regenerative braking force of the rear wheel, and increase the friction braking force by an amount corresponding to the regenerative braking force of the rear wheel to be reduced.

3. The vehicle control device according to claim 2, wherein the control command is a command to, when a brake operation change amount of the vehicle exceeds a predetermined first brake operation change amount threshold value during the turn of the vehicle, reduce the regenerative braking force of the rear wheel, and increase the friction braking force by an amount corresponding to the regenerative braking force of the rear wheel to be reduced.

4. The vehicle control device according to claim 3, wherein the control command is a command to reduce the increased friction braking force, and increase the regenerative braking force of the rear wheel by an amount corresponding to the friction braking force to be reduced, when the brake operation change amount exceeds the predetermined first brake operation change amount threshold value and then falls below a predetermined second brake operation change amount threshold value.

5. The vehicle control device according to claim 4, wherein the control command is a command to set an increase gradient of the regenerative braking force of the rear wheel to be increased when the brake operation change amount falls below the predetermined second brake operation change amount threshold value to be smaller than a reduction gradient of the regenerative braking force of the rear wheel to be reduced when the brake operation change amount exceeds the predetermined first brake operation change amount threshold value.

6. The vehicle control device according to claim 4, wherein the control command is a command to increase the friction braking force to be reduced as an estimated road surface friction coefficient increases.

7. The vehicle control device according to claim 3, wherein the predetermined first brake operation change amount threshold value is set to increase as a lateral acceleration of the vehicle decreases.

8. The vehicle control device according to claim 2, wherein the control command is a command to reduce the regenerative braking force of the rear wheel, and increase the friction braking force by an amount corresponding to the regenerative braking force of the rear wheel to be reduced, when a steering angle change amount of the vehicle exceeds a predetermined first steering angle change amount threshold value during deceleration of the vehicle through the regenerative braking force of the rear wheel of the vehicle.

9. The vehicle control device according to claim 8, wherein the control command is a command to reduce the increased friction braking force, and increase the regenerative braking force of the rear wheel by an amount corresponding to the friction braking force to be reduced, when the steering angle change amount exceeds the predetermined first steering angle change amount threshold value and then falls below a predetermined second steering angle change amount threshold value.

10. The vehicle control device according to claim 9, wherein the control command is a command to set an increase gradient of the regenerative braking force of the rear wheel to be increased when the steering angle change amount falls below the predetermined second steering angle change amount threshold value to be smaller than a reduction gradient of the regenerative braking force of the rear wheel to be reduced when the steering angle change amount exceeds the predetermined first steering angle change amount threshold value.

11. The vehicle control device according to claim 8, wherein the predetermined first steering angle change amount threshold value is set to increase as a speed of the vehicle decreases.

12. The vehicle control device according to claim 1,
wherein the regenerative wheel is the front wheel of the vehicle, and
wherein the control command is a command to, in a case in which the vehicle is to be decelerated through the regenerative braking force of the front wheel of the vehicle, when the vehicle is turned, reduce the regenerative braking force of the front wheel, and increase the friction braking force by an amount corresponding to the regenerative braking force of the front wheel to be reduced.

13. The vehicle control device according to claim 1, wherein the control command is a command to, in the case in which the vehicle is to be decelerated through the regenerative braking force of both of the front wheel and the rear wheel of the vehicle, when the vehicle is turned, reduce the regenerative braking force of the rear wheel, and increase the regenerative braking force of the front wheel by an amount corresponding to the regenerative braking force of the rear wheel to be reduced.

14. The vehicle control device according to claim 1, wherein the control command is:
a command to, in the case in which the vehicle is to be decelerated through the regenerative braking force of the regenerative wheel being any one of the front wheel and the rear wheel of the vehicle, when the vehicle is turned, reduce the regenerative braking force of the regenerative wheel, and increase the friction braking force by the amount corresponding to the regenerative braking force of the regenerative wheel to be reduced, and then, when a brake operation change amount of the vehicle falls below a predetermined brake operation change amount threshold value and a steering angle change amount falls below a predetermined steering angle change amount threshold value, reduce the increased friction braking force, and increase the regenerative braking force of the regenerative wheel by an amount corresponding to the friction braking force to be reduced; or
a command to, in the case in which the vehicle is to be decelerated through the regenerative braking force of both of the front wheel and the rear wheel of the vehicle, when the vehicle is turned, reduce the regenerative braking force of the rear wheel, and increase the regenerative braking force of the front wheel by the amount corresponding to the regenerative braking force of the rear wheel to be reduced, and then, when the brake operation change amount of the vehicle falls below the predetermined brake operation change amount threshold value and the steering angle change amount falls below the predetermined steering angle change amount threshold value, reduce the increased regenerative braking force of the front wheel, and increase the regenerative braking force of the rear wheel by an amount corresponding to the regenerative braking force of the front wheel to be reduced.

15. A vehicle control method, which is executed by a control unit included in a vehicle including a friction braking device configured to generate a friction braking force on the vehicle and a regenerative braking device configured to generate a regenerative braking force on the vehicle, the vehicle control method comprising outputting, by the control unit, a control command to:
in a case in which the vehicle is to be decelerated through a regenerative braking force of a regenerative wheel being any one of a front wheel or a rear wheel of the vehicle, when the vehicle is turned, reduce the regenerative braking force of the regenerative wheel from a regenerative braking force at a time when the vehicle is not turned, and increase the friction braking force by an amount corresponding to the regenerative braking force of the regenerative wheel to be reduced; or
in a case in which the vehicle is to be decelerated through a regenerative braking force of both of the front wheel and the rear wheel of the vehicle, when the vehicle is turned, reduce the regenerative braking force of the rear wheel from a regenerative braking force at the time when the vehicle is not turned, and increase the regenerative braking force of the front wheel by an amount corresponding to the regenerative braking force of the rear wheel to be reduced.

16. A vehicle control system, comprising:
a friction braking device configured to generate a friction braking force on a vehicle;
a regenerative braking device configured to generate a regenerative braking force on the vehicle; and
a control unit included in the vehicle and configured to output a control command to:
in a case in which the vehicle is to be decelerated through a regenerative braking force of a regenerative wheel being any one of a front wheel or a rear wheel of the vehicle, when the vehicle is turned, reduce the regenerative braking force of the regenerative wheel from a regenerative braking force at a time when the vehicle is not turned, and increase the friction braking force by an amount corresponding to the regenerative braking force of the regenerative wheel to be reduced; or
in a case in which the vehicle is to be decelerated through a regenerative braking force of both of the front wheel and the rear wheel of the vehicle, when the vehicle is turned, reduce the regenerative braking force of the rear wheel from a regenerative braking force at the time when the vehicle is not turned, and increase the regenerative braking force of the front wheel by an amount corresponding to the regenerative braking force of the rear wheel to be reduced.

17. A vehicle control device, which is included in a vehicle including a drive device configured to generate a driving force on the vehicle, the vehicle control device comprising a control part,
wherein the control part is configured to output a control command to, in a case in which the vehicle is to be accelerated through a driving force of both of a front wheel and a rear wheel of the vehicle, when the vehicle is turned, reduce the driving force of the rear wheel from a driving force at a time when the vehicle is not turned, and increase the driving force of the front wheel by an amount corresponding to the driving force of the rear wheel to be reduced.
